(19) United States
(12) Patent Application Publication
(10) Pub. No.: US 2009/0067898 A1
(43) Pub. Date: Mar. 12, 2009

(54) TONER FUSER FOR FUSING TONERS ON A PRINT MEDIUM AND RELATED LASER PRINTER

(76) Inventors: Min-Chih Tseng, Kaohsiung County (TW); Ming-Hung Hsu, Hsinchu City (TW); Ying-Ruei Li, Taipei County (TW); Hsin-Change Chen, Pingtung County (TW)

Correspondence Address: NORTH AMERICA INTELLECTUAL PROPERTY CORPORATION, P.O. BOX 506, MERRIFIELD, VA, 22116, US

(21) Appl. No.: 11/853,034

(22) Filed: Sep. 11, 2007

(51) Int. Cl. G03G 15/20

(52) U.S. Cl. 399/328; 399/331

(57) ABSTRACT

A toner fuser includes a pressure roller for pressing toners on a print medium so as to fuse the toners on a print medium, and a rolling heating component for clamping the print medium with the pressure roller and heating the pressure roller. A fusing region is formed between the pressure roller and the rolling heating component. The toner fuser further includes a rolling preheating component installed on a side of the pressure roller for preheating the pressure roller and a part of the print medium not entering into the fusing region.

### BACKGROUND OF THE INVENTION

1. Field of the Invention

The present invention relates to a toner fuser for fusing toners on a print medium and a related laser printer, and more particularly, to a toner fuser with a rolling preheating component for preheating the pressure roller so as to fuse toners on a print medium efficiently and a related laser printer.

2. Description of the Prior Art

Please refer to FIG. 1. FIG. 1 is a diagram of a laser printer 10 according to the prior art. The laser printer 10 includes a casing 12, an organic photo conductor 14, a charged roller 16, a laser scanning unit 18, a toner cartridge 20, a developer roller 22, a transfer roller 24, a toner fuser 26, and a discharge unit 28. The casing 12 is for shielding internal components of the laser printer 10. The organic photo conductor 14 is installed inside the casing 12 in a rotatable manner. The charged roller 16 installed inside the casing 12 distributes charges on a surface of the organic photo conductor 14. The laser scanning unit 18 installed inside the casing 12 projects laser beams onto the surface of the organic photo conductor 14. The toner cartridge 20 installed inside the casing 12 stores toners. The developer roller 22 installed inside the casing 12 and disposed on a side of the toner cartridge 20 is capable of absorbing the toners from the toner cartridge 20. The transfer roller 24 installed inside the casing 12 connects to a negative bias (not shown). The toner fuser 26 installed inside the casing 12 melts a plastic portion of the toner so as to fuse the toners on a print medium 40. The discharge unit 28 installed inside the casing 12 discharges the charges on the organic photo conductor 14.

The printing procedures and principles of the laser printer 10 are introduced below. First, the charged roller 16 distributes electrons and positive charges on the surface of the organic photo conductor 14. Then, the laser scanning unit 18 projects laser beams onto a specific region of the surface of the organic photo conductor 14. The organic photo conductor 14 is composed of highly-photoconductive material. When the specific region of the surface of the organic photo conductor 14 receives the laser beams emitted from the laser scanning unit 18, the collisions between photons of the laser beams and electrons of the highly-photoconductive material ionize the electrons and make the specific region conductive, so as to form an electrostatic image with lower voltage. Voltage at a position of the electrostatic image is related to the frequency of the laser beam. In other words, the higher the frequency of the laser beam projected onto a point, the lower the voltage of the point, and vice versa. Subsequently, when the organic photo conductor 14 rotates to a position where the electrostatic image is adjacent to the developer roller 22, because the developer roller 22 has already absorbed charged toners stored in the toner cartridge 20, parts of the electrostatic image of certain voltages will absorb the charged toners from the developer roller 22. The lower the voltage of a point on the electrostatic image is, the more charged toner the point will absorb. Next, when the organic photo conductor 14 rotates to a position where the electrostatic image is adjacent to the transfer roller 24, because the negative bias the transfer roller 24 is electrically connected to is much lower than the voltage at any position on the electrostatic image (meaning the absolute value of the minus bias is greater than the absolute value of the voltage at any position on the electrostatic image), the transfer roller 24 is able to transfer the charged toners on the electrostatic image to the print medium 40 between the transfer roller 24 and the organic photo conductor 14. At this time, the toners stay on the print medium 40 temporarily because of the attraction of static electricity, and therefore any vibration of the laser printer 10 or other external forces will shift the toner on the print medium 40. But after the print medium 40 passes through the toner fuser 26, the heat generated by the toner fuser 26 will melt the plastic portion of the toners on the print medium 40 so as to make the toners stick to the print medium 40. After the transfer roller 24 transfers the toners on the electrostatic image to the print medium 40, and the organic photo conductor 14 rotates to a position where the electrostatic image is adjacent to the discharge unit 28, the discharge unit 28 will discharge the charges on the electrostatic image completely, so that when the organic photo conductor 14 rotates to a specific region (the electrostatic image has already disappeared) adjacent to the charged roller 16, the charged roller 16 is able to redistribute charges on the surface of the organic photo conductor 14. In addition, the laser scanning unit 18 includes an optical system module 30, an optical scanning module 32, a curved lens 33, and a reflector module 34. The optical system module 30 generating laser beams according to print data includes a laser beam source 36 for emitting the laser beams, and an optical optimizing element 38 for optimizing the laser beams emitted from the laser beam source 36. The optical scanning module 32 is for reflecting the laser beams generated by the optical system module 30. The curved lens 33 for reflecting the laser beams reflected from the optical scanning module 32 can be an f-θlens. The reflector module 34 is for reflecting the laser beams reflected from the curved lens 33 to the organic photo conductor 14.

However it takes a certain period to preheat the conventional laser printer so that the toner fuser can reach the temperature of fusing the toners on the print medium after the laser printer is turned on. It's inconvenient for users to wait the preheating period of the laser printer. U.S. Pat. No. 7,016,638 discloses a belt for preheating a pressure roller rapidly. However it has disadvantages of high cost of the belt and easy deviation of the belt. There is a need to find a preheating mechanism for the toner fuser with low cost and good reliability.

### SUMMARY OF THE INVENTION

It is therefore a primary objective of the claimed invention to provide a toner fuser with a rolling preheating component for preheating the pressure roller so as to fuse toners on a print medium efficiently and a related laser printer for solving the above-mentioned problem.

According to the claimed invention, a toner fuser includes a pressure roller for pressing toners on a print medium so as to fuse the toners on a print medium, and a rolling heating component for clamping the print medium with the pressure roller and heating the pressure roller. A fusing region is formed between the pressure roller and the rolling heating component. The toner fuser further includes a rolling preheating component installed on a side of the pressure roller for preheating the pressure roller and a part of the print medium not entering into the fusing region.

According to the claimed invention, a laser printer includes a casing, a toner cartridge installed inside the casing for storing toners, a developer roller installed inside the casing and disposed on a side of the toner cartridge for absorbing the toners from the toner cartridge, an organic photo conductor installed inside the casing in a rotatable manner for absorbing the toners on the developer roller, a charged roller installed inside the casing for distributing charges on a surface of the organic photo conductor, a laser scanning unit installed inside the casing for projecting laser beams onto the surface of the organic photo conductor, a transfer roller installed inside the casing for transferring the toners to a print medium between the transfer roller and the organic photo conductor, and a toner fuser installed inside the casing. The toner fuser includes a pressure roller for pressing the toners on the print medium so as to fuse the toners on the print medium, and a rolling heating component for clamping the print medium with the pressure roller and heating the pressure roller. A fusing region is formed between the pressure roller and the rolling heating component. The toner fuser further includes a rolling preheating component installed on a side of the pressure roller for preheating the pressure roller and a part of the print medium not entering into the fusing region.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a laser printer according to the prior art.

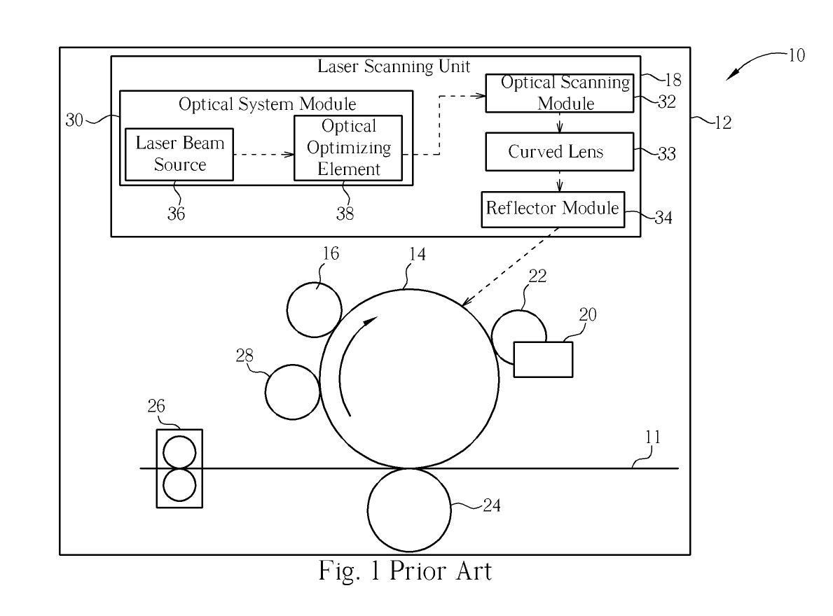

FIG. 2 is a diagram of a laser printer of the present invention.

FIG. 3 is a diagram of a toner fuser of the present invention.

### DETAILED DESCRIPTION

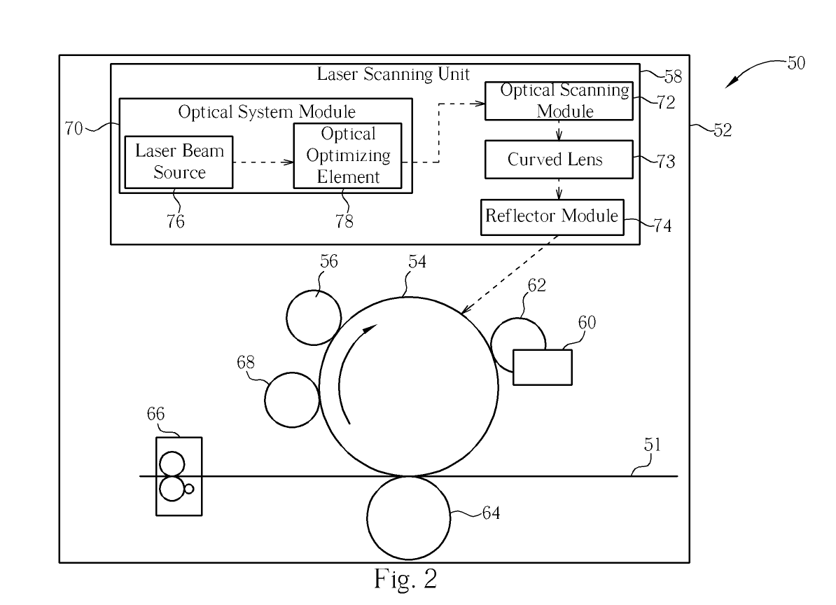

Please refer to FIG. 2. FIG. 2 is a diagram of a laser printer 50 of the present invention. The laser printer 50 includes a casing 52, an organic photo conductor 54, a charged roller 56, a laser scanning unit 58, a toner cartridge 60, a developer roller 62, a transfer roller 64, a toner fuser 66, and a discharge unit 68. The casing 52 is for shielding internal components of the laser printer 50. The organic photo conductor 54 is installed inside the casing 52 in a rotatable manner. The charged roller 56 installed inside the casing 52 distributes charges on a surface of the organic photo conductor 54. The laser scanning unit 58 installed inside the casing 52 projects laser beams onto the surface of the organic photo conductor 54. The toner cartridge 60 installed inside the casing 52 stores toners. The developer roller 62 installed inside the casing 52 and disposed on a side of the toner cartridge 60 is capable of absorbing the toners from the toner cartridge 60. The transfer roller 64 installed inside the casing 52 connects to a negative bias (not shown). The toner fuser 66 installed inside the casing 52 melts a plastic portion of the toner so as to fuse the toners on a print medium 51. The discharge unit 68 installed inside the casing 52 discharges the charges on the organic photo conductor 54.

The printing procedures and principles of the laser printer 50 are introduced below. First, the charged roller 56 distributes electrons and positive charges on the surface of the organic photo conductor 54. Then, the laser scanning unit 58 projects laser beams onto a specific region of the surface of the organic photo conductor 54. The organic photo conductor 54 is composed of highly-photoconductive material. When the specific region of the surface of the organic photo conductor 54 receives the laser beams emitted from the laser scanning unit 58, the collisions between photons of the laser beams and electrons of the highly-photoconductive material ionize the electrons and make the specific region conductive, so as to form an electrostatic image with lower voltage. Voltage at a position of the electrostatic image is related to the frequency of the laser beam. In other words, the higher the frequency of the laser beam projected onto a point, the lower the voltage of the point, and vice versa. Subsequently, when the organic photo conductor 54 rotates to a position where the electrostatic image is adjacent to the developer roller 62, because the developer roller 62 has already absorbed charged toners stored in the toner cartridge 60, parts of the electrostatic image of certain voltages will absorb the charged toners from the developer roller 62. The lower the voltage of a point on the electrostatic image is, the more charged toner the point will absorb. Next, when the organic photo conductor 54 rotates to a position where the electrostatic image is adjacent to the transfer roller 64, because the negative bias the transfer roller 64 is electrically connected to is much lower than the voltage at any position on the electrostatic image (meaning the absolute value of the minus bias is greater than the absolute value of the voltage at any position on the electrostatic image), the transfer roller 64 is able to transfer the charged toners on the electrostatic image to the print medium 51 between the transfer roller 64 and the organic photo conductor 54. At this time, the toners stay on the print medium 51 temporarily because of the attraction of static electricity, and therefore any vibration of the laser printer 50 or other external forces will shift the toner on the print medium 51. But after the print medium 51 passes through the toner fuser 66, the heat generated by the toner fuser 66 will melt the plastic portion of the toners on the print medium 51 so as to make the toners stick to the print medium 51. After the transfer roller 64 transfers the toners on the electrostatic image to the print medium 51, and the organic photo conductor 54 rotates to a position where the electrostatic image is adjacent to the discharge unit 68, the discharge unit 68 will discharge the charges on the electrostatic image completely, so that when the organic photo conductor 54 rotates to a specific region (the electrostatic image has already disappeared) adjacent to the charged roller 56, the charged roller 56 is able to redistribute charges on the surface of the organic photo conductor 54. In addition, the laser scanning unit 58 includes an optical system module 70, an optical scanning module 72, a curved lens 73, and a reflector module 74. The optical system module 70 generating laser beams according to print data includes a laser beam source 76 for emitting the laser beams, and an optical optimizing element 78 for optimizing the laser beams emitted from the laser beam source 76. The optical scanning module 72 is for reflecting the laser beams generated by the optical system module 70. The curved lens 73 for reflecting the laser beams reflected from the optical scanning module 72 can be an f-θlens. The reflector module 74 is for reflecting the laser beams reflected from the curved lens 73 to the organic photo conductor 74.

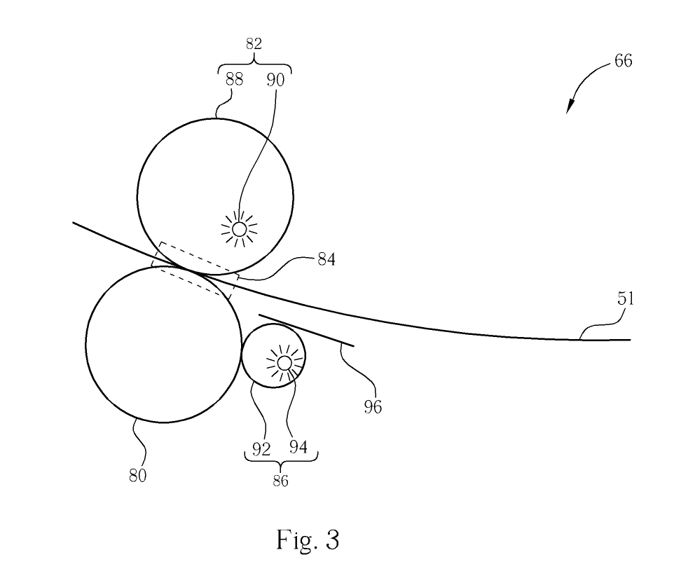

Please refer to FIG. 3. FIG. 3 is a diagram of the toner fuser 66 of the present invention. The toner fuser 66 includes a pressure roller 80 for pressing the toners on the print medium 51 so as to fuse the toners on the print medium 51, a rolling heating component 82 for clamping the print medium 51 with the pressure roller 80 and heating the pressure roller 80. A fusing region 84 is formed between the pressure roller 80 and the rolling heating component 82. The toner fuser 66 further includes a rolling preheating component 86 installed on a side of the pressure roller 80. The rolling preheating component 86 can contact with or be adjacent to the pressure roller 80. The rolling preheating component 86 is for preheating the pressure roller 80 and a part of the print medium 51 not entering into the fusing region 84. The rolling heating component 82 includes a heating roller 88, and a first heat source 90 installed inside the heating roller 88 for generating heat so as to increase the temperature of the surface of the heating roller 88. The first heat source 90 can be a light bulb. The rolling preheating component 86 includes a preheating roller 92. The preheating roller 92 can contact with or be adjacent to the pressure roller 80. The rolling preheating component 86 further includes a second heat source 94 installed inside the preheating roller 92 for generating heat so as to increase the temperature of the surface of the preheating roller 92. The second heat source 94 can be a light bulb. When the rolling heating component 82 is heating the pressure roller 80, the rolling preheating component 86 can heat the pressure roller 80 simultaneously so as to reduce the duration of reaching the temperature for fusing the toners on the print medium 51. The plastic portion of the toners on the print medium 51 can be melted, and the pressure roller 80 presses the melted toners on the fusing region 84 of the print medium 51 so as to make the toners stick to the print medium 51 and accomplish the print procedure. Besides, the rolling preheating component 86 can be disposed below a guide mechanism 96. The guide mechanism 96 is for guiding the print medium 51 into the fusing region 84 between the pressure roller 80 and the rolling heating component 82. The rolling preheating component 86 can preheat a part of the print medium 51 entering the fusing region 84 in advance so as to remove mist on the print medium 51 and the toners thereon. It can increase the print speed (reduce the duration of reaching the temperature for fusing the toners on the print medium 51) and reach better fusing quality simultaneously.

In contrast with the prior art, the present invention utilizes a rolling preheating component for preheating the pressure roller so as to reduce the duration of reaching the temperature for fusing the toners on the print medium. Therefore it can reduce an initial heating period after turning on the laser printer for saving time cost. Furthermore, the rolling preheating component can preheat the print medium not entering into the fusing region so as to remove mist on the print medium and the toners thereon. It can increase the print speed (reduce the duration of reaching the temperature for fusing the toners on the print medium) and reach better fusing quality simultaneously.

Those skilled in the art will readily observe that numerous modifications and alterations of the device and method may be made while retaining the teachings of the invention. Accordingly, the above disclosure should be construed as limited only by the metes and bounds of the appended claims.

1-6. (canceled)

7. A laser printer comprising:
a casing;
a toner cartridge installed inside the casing for storing toners;
a developer roller installed inside the casing and disposed on a side of the toner cartridge for absorbing the toners from the toner cartridge;
an organic photo conductor installed inside the casing in a rotatable manner for absorbing the toners on the developer roller;
a charged roller installed inside the casing for distributing charges on a surface of the organic photo conductor;
a laser scanning unit installed inside the casing for projecting laser beams onto the surface of the organic photo conductor;
a transfer roller installed inside the casing for transferring the toners to a print medium between the transfer roller and the organic photo conductor; and
a toner fuser installed inside the casing, the toner fuser comprising:
a pressure roller for pressing the toners on the print medium so as to fuse the toners on the print medium;
a rolling heating component for clamping the print medium with the pressure roller and heating the pressure roller, and a fusing region being formed between the pressure roller and the rolling heating component; and
a rolling preheating component installed on a side of the pressure roller for preheating the pressure roller and a part of the print medium not entering into the fusing region.

8. The laser printer of claim 7 wherein the rolling heating component comprises:
a heating roller; and
a first heat source installed inside the heating roller for generating heat.

9. The laser printer of claim 8 wherein the first heat source is a light bulb.

10. The laser printer of claim 7 wherein the rolling preheating component comprises:
a preheating roller; and
a second heat source installed inside the preheating roller for generating heat.

11. The laser printer of claim 10 wherein the second heat source is a light bulb.

12. The laser printer of claim 7 wherein the preheating roller contacts with the pressure roller.
